(19) United States
(12) Patent Application Publication
(10) Pub. No.: US 2019/0227159 A1
(43) Pub. Date: Jul. 25, 2019

(54) LOW C-SWAP FMCW RADAR SYSTEM FOR SENSING ILLEGAL FLIGHT OF LOW-FLYING DRONE

(71) Applicant: Electronics and Telecommunications Research Institute, Daejeon (KR)

(72) Inventors: Sang Hyouk CHOI, Seoul (KR); Jae Young AHN, Daejeon (KR); Man Seok UHM, Daejeon (KR); Jong Suk CHAE, Daejeon (KR)

(73) Assignee: Electronics and Telecommunications Research Institute, Daejeon (KR)

(21) Appl. No.: 16/254,256

(22) Filed: Jan. 22, 2019

(30) Foreign Application Priority Data
Jan. 22, 2018 (KR) 10-2018-0007582
Jan. 2, 2019 (KR) 10-2019-0000314

(51) Int. Cl. G01S 13/88; G08G 5/00; B64C 39/02; G01S 13/08; G01S 13/50

(52) U.S. Cl. CPC G01S 13/88; G08G 5/0082; G01S 13/50; B64C 39/024; G01S 13/08; G08G 5/0026

(57) ABSTRACT

Disclosed is a method of sensing illegal flight of a low-flying drone. Here, the method of sensing illegal flight includes: changing a direction of a beam on the basis of a preset period; and detecting an object by using the beam changed on the basis of the preset period. Here, the direction of the beam is changed on the basis of a first direction and a second direction. The first direction is changed on the basis of conversion of a center frequency, and the second direction is changed on the basis of a phase and a particular value.

### CROSS REFERENCE TO RELATED APPLICATION

The present application claims priority to Korean Patent Application No. 10-2018-0007582 and 10-2019-0000314, filed Jan. 22, 2018 and Jan. 2, 2019, the entire contents of which is incorporated herein for all purposes by this reference.

### BACKGROUND OF THE INVENTION

### Field of the Invention

The present invention relates to a low C-SWAP FMCW radar system based on a hybrid electronically scanned array radar method for sensing illegal flight.

The present invention relates to a method of sensing illegal flight of a low-flying drone.

### Description of the Related Art

As drones mainly used for military use become and cheaper, they are widely used in various fields such as agriculture Where they are used for pesticide spraying, the public services where they are used for firefighting, measuring, forest monitoring, and by hobbyists for photographing, and the like. With this trend, the number of cases, in h drones maliciously or accidently invade a no-fly zone that is nationally or industrially protected has increased, and accordingly, the scale of damage has also increased.

In order to detect these illegal drones, militarily, assault-type, reconnaissance-type drones infiltrating at a low altitude or medium long-range detection tracking radar for detecting and tracking shells are used. However, it is mainly pulse-Doppler radar with an active electronically scanned array (AESA) scheme, which is expensive and not suitable for civilian use. Due to the high peak power in a pulse-Doppler method, it is difficult to implement the semiconductor of a transmitter. In order to lower the peak power, when increasing the pulse width, a blind distance at which reception is impossible at the time of pulse transmission is long, which is inadequate for short-range radar. Further, when applying the active electronically scanned array to a planar antenna, namely, to the azimuth and the elevation, the number of RF components, such as a high power amplifier, a transmission core chip, a low-noise amplifier, a reception core chip, and the like, of an RF transmitter increases two-dimensionally, occupying to more than ⅔ of the radar price and resulting in increase in power consumption. Therefore, it is difficult to reduce the size and weight.

Technical attempts have been made to reduce the distance of low altitude radar for military use and to lower the price. Particularly, many active electronically scanned array radar systems to which frequency-modulated continuous-waves (FMCW) are applied instead of the pulse-Doppler method have proposed. However, RF components that constitute an array antenna are expensive, so that it is not easy to implement a high-gain antenna and there is limitation in lowering the price.

In the UK, Blighter has released cost-effective low altitude radar that simultaneously uses a passive electronically scanned array (PESA) scheme of a frequency scanned type, in which expensive RF components are not used, and frequency-modulated continuous-waves, which may be similar to the document 1 of related art (U.S. Pat. No. 7,659,849 B2),

However, this scheme is a 2D scheme wherein electronic scanning is possible only in a horizontal direction but electronic scanning is impossible in a vertical direction. Therefore, it is impossible to control the beam width in an elevation direction and the direction, so that it is impossible to disperse the influence of clutter that comes from one cell in a vertical direction. Thus, it is difficult to remove clutter. There is a problem, which is one of challenges that is required to be addressed in the frequency-modulated continuous-wave scheme, wherein a dynamic range of a receiver is very likely to be damaged from around clutter which is always present.

Further, the beam in the vertical direction is required to cover at least a 15 to 20 degree angle, so that a single beam in an elevation direction also has limitations of increasing antenna gain. Radar cooperates with an image signal tracking/identifying device. Even when additional analysis is conducted on a target detected by radar, due to low resolution in the elevation direction, an image of a very long rectangular area in the elevation direction is obtained by an image tracking/identifying device in cooperation with radar. Therefore, there is a problem that the probability of failing in tracking increases because the area in which a suspicious target is detected is wide.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a method of sensing illegal flight of a low-flying drone.

The present invention is intended to provide a method of detecting in advance an illegal threat that small drones which fly at a low altitude of 200 to 300 m or less invade a secure area set as a no-fly zone.

The present invention is intended to propose a method for implementing low-flying drone detection radar at a low price level for civilian use with sufficient function and performance to sense an illegal flight and respond thereto.

It is to be understood that technical problems to be solved by the present invention are not limited to the aforementioned technical problems and other technical problems which are not mentioned will be apparent from the following description to a person with an ordinary skill in the art to which the present invention pertains.

In order to achieve the above object, according to an embodiment of the present invention, there is provided a method of sensing illegal flight of a low-flying drone, the method including: changing a direction of a beam on the basis of a preset period; and detecting an object by using the to beam changed on the basis of the preset period. Here, the direction of the beam may be changed on the basis of a first direction and a second direction, the first direction may be changed on the basis of conversion of a center frequency, and the second direction may be changed on the basis of a phase and a particular value.

Also, according to an embodiment of the present invention, there is provided an apparatus for sensing illegal flight of a low-flying drone, the apparatus including: a transmission and reception unit; and a processor for controlling the transmission and reception unit. Here, the processor may be configured to: change a direction of a beam on the basis of a preset period; and detect an object using the beam changed on the basis of the preset period. The direction of the beam may be changed on the basis of a first direction and a second direction, the first direction may be changed on the basis of conversion of a center frequency, and the second direction may be changed on the basis of a phase and a particular value.

Also, according to an embodiment of the present invention, there is provided a system for sensing illegal flight of a low-flying drone, the system including: an electro-optical and infrared (EO/IR) device; multiple radar panels; and a control device for controlling the EO/IR device and the multiple radar panels. Here, an object may be detected by changing a direction of a beam at a preset period in the radar panels, and information on the detected object may be transmitted to the control device. The direction of the beam may be changed on the basis of a first direction and a second direction, the first direction may be changed on the basis of conversion of a center frequency, and the second direction may be changed on the basis of a phase and a particular value.

The following may be applied in common to the method, apparatus and system for sensing illegal flight of the low-flying drone.

According to an embodiment of the present invention, when the direction of the beam is changed on the basis of the preset period, the first direction may be changed first, and then the second direction may be changed.

Here, according to an embodiment of the present invention, the first direction may be set on the basis of a first center frequency, and at the first center frequency, when all sequential changes are performed in a range in which the second direction is able to be changed, the first center frequency may be changed into a second center frequency.

Here, according to an embodiment of the present invention, the first direction may be set on the basis of the second center frequency, and at the second center frequency, all sequential changes may be performed in a range in which the second direction is able to be changed.

Also, according to an embodiment of the present invention, the second direction may be changed on the basis of phase shift and digital attenuation.

Also, according to an embodiment of the present invention, the first direction may be an elevation direction, and the second direction may be an azimuth direction.

Also, according to an embodiment of the present invention, the number of the center frequencies may be four.

According to the present invention, it is possible to provide a method of sensing illegal flight of a low-flying drone.

According to the present invention, it is possible to provide a method of detecting in advance an illegal threat that small drones which fly at a low altitude of 200 to 300 m or less invade a secure area set as a no-fly zone.

According to the present invention, it is possible to propose a method for implementing low-flying drone detection radar at a low price level for civilian use with sufficient function and performance to sense an illegal flight and respond thereto.

According to the present invention, with a hybrid electronically scanned array (HESA) scheme in which a frequency array is applied in a vertical direction and an active electronically scanned method is used in a horizontal direction, it is possible to compensate for the disadvantages of a horizontal direction frequency scanned array (PESA) scheme and to mediate between to performance and price.

Effects that may be obtained from the present invention will not be limited to only the above described effects. In addition, other effects which are not described herein will become apparent to those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating a typical EO/IR cooperation radar system for detecting and identifying small drones according to an embodiment of the present invention;

FIG. 2 is a diagram illustrating a general configuration of an FMCW HESA radar panel according to an embodiment of the present invention;

FIG. 3 is a diagram illustrating a configuration of a unit according to an embodiment of the present invention;

FIG. 4 is a diagram illustrating a configuration of a hybrid electronically scanned array radar scheme according to an embodiment of the present invention;

FIG. 5 is a diagram illustrating an example in which four center frequencies are assigned in the Ku band according to an embodiment of the present invention;

FIG. 6 is a scan timing diagram of FMCW radar according to an embodiment of the present invention;

FIG. 7 is a flowchart illustrating a method of sensing illegal flight of a low-flying drone according to an embodiment of the present invention; and

FIG. 8 is a diagram illustrating a configuration of an apparatus for sensing illegal flight of a to low-flying drone according to an embodiment of the present invention.

### DETAILED DESCRIPTION OF THE INVENTION

Hereinafter, preferred embodiments of the present invention will be described in detail with reference to the drawings. In the following description and the accompanying drawings, substantially same elements are denoted by the same reference numerals, and a repeated description thereof will be omitted. Also, in describing the present invention, it is decided that if a detailed description of the known function or configuration related to the present invention makes the subject matter of the present invention unclear, the detailed description will be omitted. Also, parts that are not related to the description of the present invention are omitted in the drawings, and like reference numerals designate like parts.

In the present invention, when an element is “coupled to”, “combined with”, or “connected to” another element, it can be directly coupled to the other element or intervening elements may be present therebetween. Also, when a component “comprises” or “includes” an element, unless there is another opposite description thereto, the component does not exclude other elements but may further include the elements.

In the present invention, the terms “first”, “second”, etc. are only used to distinguish one element from another element. Unless specifically stated otherwise, the terms do not denote an order or importance. Thus, without departing from the scope of the present invention, a first element of an embodiment could be termed a second element of another embodiment. Similarly, a second element of an embodiment could also be termed a first element of another embodiment.

In the present invention, constituent elements that are distinguished from each other to clearly describe each feature do not necessarily denote that the constituent elements are separated. That is, a plurality of constituent elements may be integrated into one hardware or software unit, or to one constituent elements may be distributed into a plurality of hardware or software units. Accordingly, even if not mentioned, the integrated or distributed embodiments are included in the scope of the present invention.

In the present invention, constituent elements described in various embodiments do not denote essential elements, and some of the elements may be optional. Accordingly, an is embodiment that includes a subset of constituent elements described in another embodiment is included in the scope of the present invention. Also, an embodiment that includes the constituent elements which are described in the various embodiments and additional other elements is also included in the scope of the present invention.

In order to achieve the above-described object of the present invention, an antenna for a hybrid electronically scanned array radar scheme may be used in the present invention.

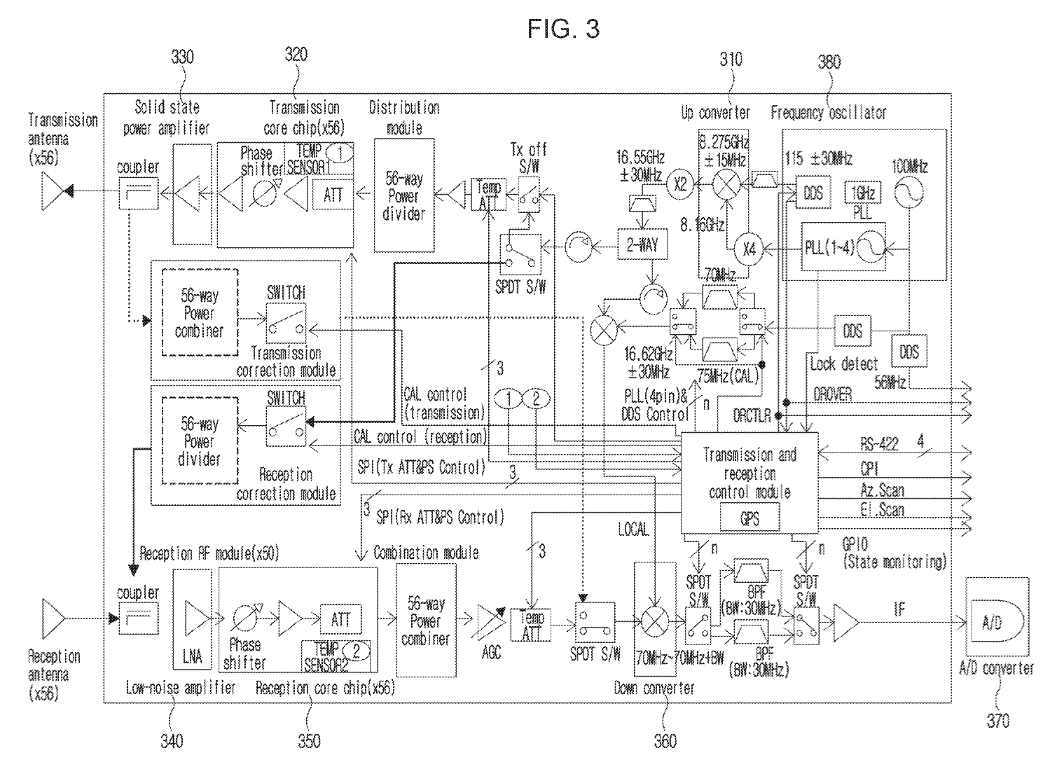

Here, the hybrid electronically scanned array radar scheme may be a scheme that in a horizontal direction, one traveling wave leakage line is provided with respect to each of M channels in an active electronically scanned array, each line has P leakage slots, and according to the frequency channel, and beams having different directivity angles are formed in a vertical direction. More specifically, FIG. 3 may be referenced, and this will be described later.

Accordingly, in the case of beam steering in the azimuth direction, phases of M phase shifters connected to M channels are adjusted like the electronically scanned scheme. When necessary, the shape of the beam may be controlled by adjusting values of M digital attenuators equipped with the phase shifters. Also, in the case of beam steering in the elevation direction, when converting a center frequency generated by a frequency oscillator, the number of center frequencies may be required to be equal to the number of beams to be steered in the elevation direction. A characteristic of a traveling wave leakage line is that the direction of the beam to be steered changes when converting the center frequency. The number P of leakage slots in each line may be a value that is required to be adjusted according to the beam width in the elevation to direction and the beam gain.

Further, for example, in order to operate radar for civilian use, it is necessary to assign the radar frequency for civilian use from the related government departments. That is, the frequency for using radar may be required to be set as a licensed band. Accordingly, frequency resources may be limited. When there are multiple performs that want to use frequency, there is a problem with frequency utilization. That is, the frequency may be a public resource having a high value. As described above, when the entire band of 1.5 GHz is used as the radar frequency, frequency use may be limited. That is, since not all frequencies to be used may be in the licensed band, there may be problems in operation. Considering this, the case of using only four center frequencies will be described below. That is, the case in which only four elevation direction beams are used will be described as an embodiment. That is, four frequency bands may be used. However, considering permission for a frequency band and a service environment, the number of center frequencies to be used may be adjusted and is not limited to the above-described embodiment.

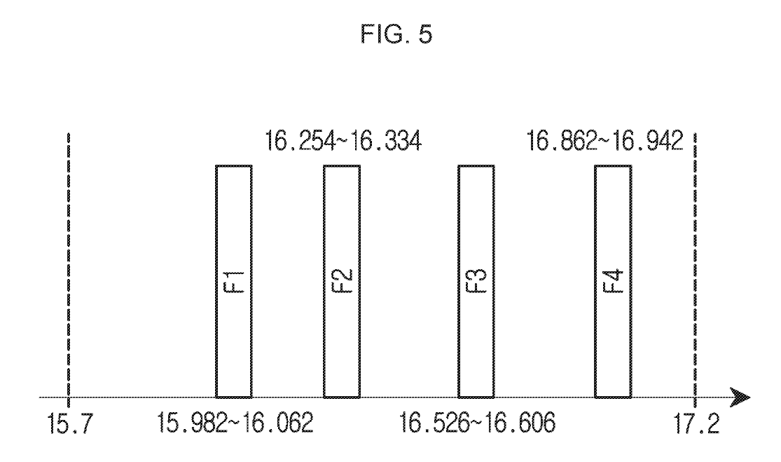

For example, a value reflecting the bandwidth of an FMCW signal on the basis of the center frequency may be the frequency bandwidth that radar uses. For example, when the frequency is assigned in the Ku band, a bandwidth as shown in FIG. 5 may be provided for example, which will be described later.

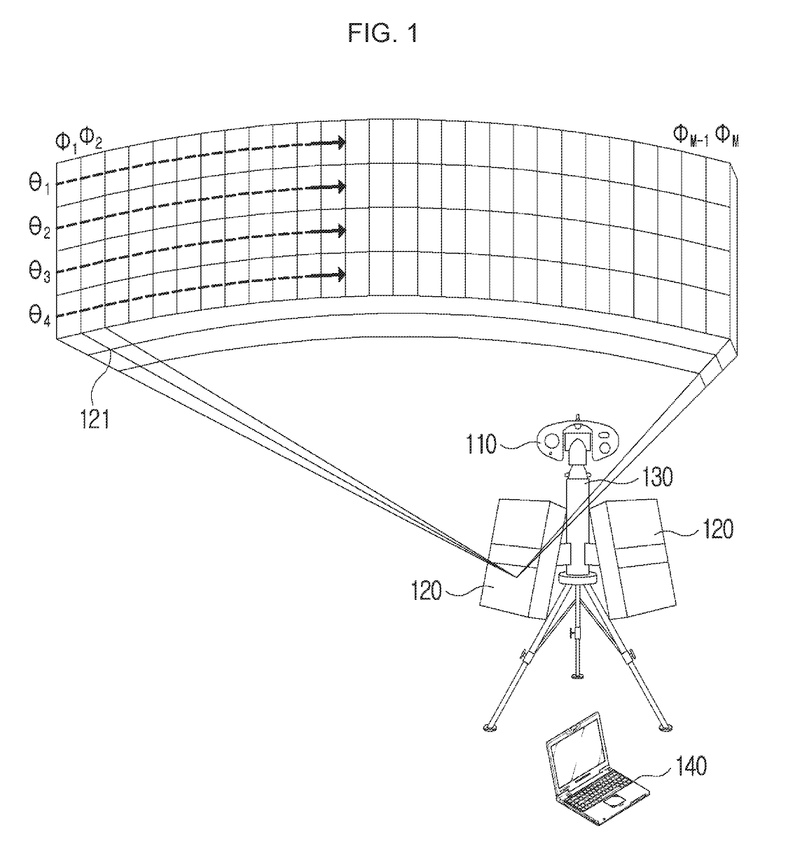

Further, for example, at an antenna designing step, for a surveillance area that radar performs detection, a maximum detection distance, a detection area in an azimuth direction, and a detection area in an elevation direction may be calculated first. That is, as information on a radar surveillance area and direction information, azimuth and elevation direction information may be considered first. Here, on the basis of the assigned center frequency, the beam width in the elevation direction and the direction of the beam may be designed in such a manner as to have spatial cells as shown in FIG. 1.

Here, for example, referring to FIG. 1, information on a spatial cell 121 may be designed assuming that each size of an azimuth direction and an elevation direction has a beam width of 3 dB. That is, as the spatial cell 121 at the maximum detection distance, the elevation direction size may be designed assuming the size of beam width of 3 dB in the elevation direction, and the azimuth direction size may be designed assuming the size of beam width of 3 dB in the azimuth direction 3dB.

Here, for example, according to the beam width of 3 dB in the elevation direction, the length of the traveling wave leakage line and the number P of leakage slots in the line may be determined, and according to the beam with of 3 dB in the azimuth direction, the number M of arrays in the azimuth direction and the number M of active elements may be determined. Here, on the basis of the above description, radar needs to monitor the determined surveillance area repeatedly at regular intervals.

Here, in the case of the FMCW-type radar in which the spatial cell 121 shown in FIG. 1 is repeatedly monitored, phase noise of the frequency oscillator may be larger than a far target signal. Therefore, it takes time to stabilize the phase noise of the frequency oscillator to a very low level. Here, for example, for periodic monitoring, the spatial cell 121 may be monitored in a manner that the center frequency stabilized by the frequency oscillator is used continuously.

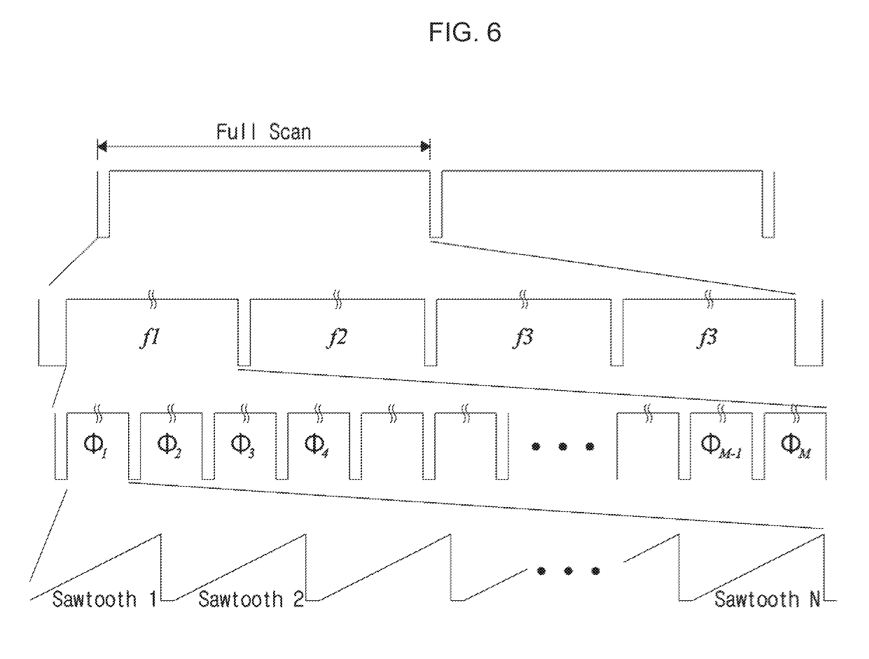

More specifically, after converting the beam in the elevation direction, the beam in the azimuth direction may be continuously steered. Then, when reaching the end of the surveillance area in the azimuth direction, the beam in the elevation direction is converted again. Then, the beam in the azimuth direction may be implemented in a continuously steered manner. That is, with respect to each elevation direction, after performing monitoring by continuously steering the beam in the azimuth direction the beam in the elevation direction is changed and monitoring is performed again, thereby performing scanning based on the spatial cell 121. Here, for example, FIG. 6 shows a scan timing diagram based on the above-mentioned method. Here, referring to FIG. 6, only four center frequencies may be considered as described above, but it is not limited to thereto. Here, as a full scan, a period for each center frequency may be set in an elevation direction. Further, as described above, with respect to one elevation direction, the azimuth is continuously steered, so that scanning may be performed on the basis of each period. In the meantime, for each azimuth direction, scanning may be performed with a predetermined period. That is, on the basis of the method shown in FIG. 6, radar performs scanning.

In the meantime, for example, cooperation between a configuration unit of radar and an electro-optical and infrared (EO/IR) imaging device may he considered. Here, referring to FIG. 1, shown is an EO/IR cooperation radar system for detecting and identifying small drones. The EO/IR cooperation radar system may include an EO/IR device 110, multiple radar panels 120, a support 130 for mounting these devices, and a command/control device 140.

For example, the system may be designed in such a manner than when a small drone invades a no-fly zone, such as a venue, an important facility, an airfield, a national border, and the like, the radar panel 120 covering the corresponding sector at a distance where sufficient response time is secured detects the small drone. In the meantime, the radar panel periodically transmits information on the spatial cell 121 where the detected target is positioned, namely, estimated azimuth, elevation, distance, and velocity data to the command/control device 140. The command/control device performs cumulative analysis or data filtering on the information on the spatial cell for transmission to the EO/IR device 110. Here, the command/control device 140 integrates information between radar panels with respect to the corresponding target for display on a screen as pictures and data, and changes radar parameters related to an operation of radar, search, detection, and the like on the basis of a user input, and it is not limited to the above-described embodiment.

Further, for example, the radar system may obtain, on the basis of the user input, Doppler sound information on a particular target, Doppler analysis information, and the like. Here, the ECM device 110 that received information on the spatial cell 121 where the target is positioned to adjusts horizontal and vertical angles of an EO/IR camera into a direction toward the cell and appropriately zooms in to analyze the image, thereby obtaining the accurate position within the spatial cell and the image of the target.

Further, the EO/IR device may transmit detailed position data and image of the analyzed target to the command/control device 140. The command/control device 140 may integrate the received detailed information of the target with radar information for display on the screen. Here, for example, a type of target, and the like may be identified viewing the image, and the EO/IR device 110 or the command/control device 140 may automatically analyze the characteristic of the target using advanced technology, such as artificial intelligence, and the like. It is not limited to the above-described embodiment. That is, with respect to the method of identifying the target, an additional operation may be performed, and it is not limited to the above-described embodiment

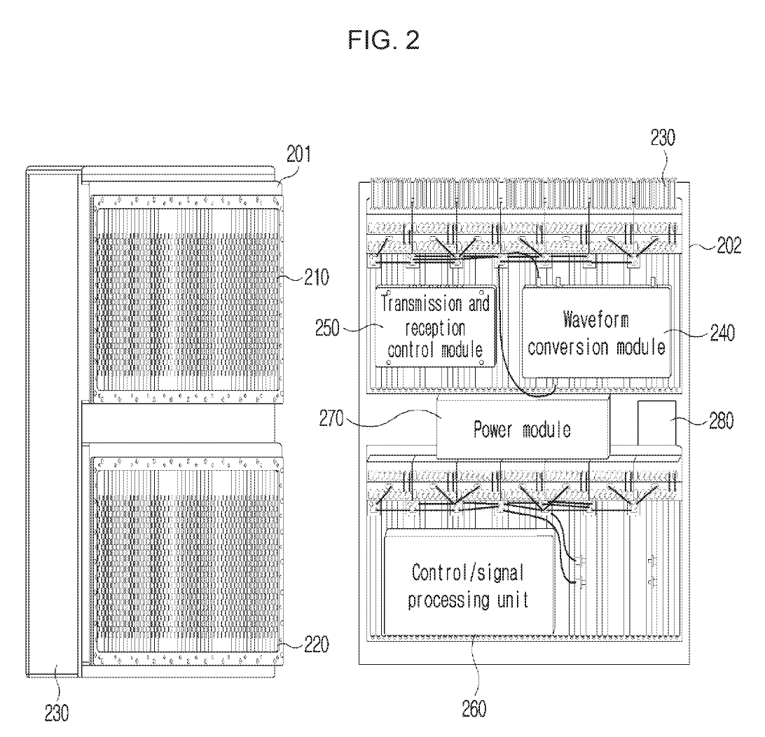

FIG. 2 is a diagram illustrating a configuration of an FMCW HESA radar panel according to the present invention. Here, a front surface portion 201 of the antenna may be provided with at least one among a transmission antenna 210, a reception antenna 220, and a housing 230 considering heat radiation. Further, a rear surface portion 202 of the antenna may be provided with at least one among a waveform generator 240, a transmission and reception unit 250, a radar signal processing unit 260, a panel power unit 270, and a panel communication unit 290. That is, the HESA radar panel may, on the basis of the above-described configuration, adjust the elevation direction and the azimuth direction to scan the object, and it is not limited to the above-described embodiment.

FIG. 3 is a diagram illustrating the transmission and reception unit 250. Here, the transmission and reception unit 250 for a transmission channel may include at least one among an upconverter 310, a transmission core chip 320, and a solid state power amplifier 330. Further, the transmission and reception unit for a reception channel may include at least one among a low-noise amplifier 340, a reception core chip 350, a downconverter 360, and an A/D converter 370. Here, to the transmission channels and the reception channels may be as many as the number of active elements of the transmission antenna and the number of active elements of the reception antenna, respectively. That is, in the case of HESA radar, it may be the number of horizontal plane control elements of transmission and reception antennas. Here, for example, the frequency oscillator 380 may use the Ku-band in which wideband is possible for frequency scanning. Table 1 shows an example of frequency, wavelength, and an elevation direction angle in the case of covering an elevation of ±10 degrees using four frequencies in the Ku-band, but it is not limited thereto.

TABLE 1

| Frequency | 3 dB beam coverage | Line length between elements |
|---|---|---|
| (GHz) | (angle) | (mm) |
| 15.71 | −7.5 | 9.4 |
| 15.99 | −2.5 | |
| 16.31 | 2.5 | |
| 16.682 | 7.5 | |

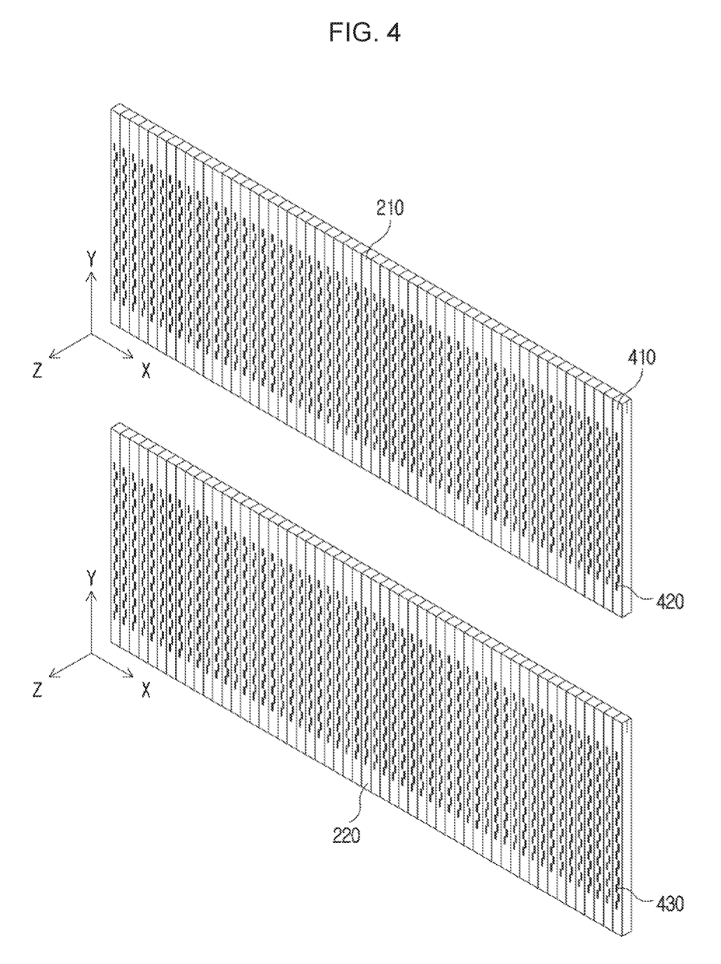

FIG. 4 shows a configuration of the transmission antenna 210 and the reception antenna 220 that constitute the hybrid electronically scanned array radar scheme according to the present invention. Here, in the horizontal direction of the transmission antenna 210, each of the M transmission channels in an active electronically scanned array may have one traveling wave leakage transmission line 410. Further, each transmission line 410 may have P leakage slots 420, and according to the transmission frequency channel, beams with different directivity angles may be formed in the vertical direction. Here, for example, the transmission line may be made of a spherical waveguide, a circular waveguide, a coaxial line, or a substrate integrated waveguide (SIW) with low loss.

In the meantime, the reception antenna 220 has the same structure as the transmission antenna, and may have the number N of active elements in a horizontal direction and the number Q of leakage slots 430 in a vertical direction. Here, M may be set to be equal to or different from to N. Also, P may be set to be equal to or different from Q. In the case of the reception antenna, the received power is lower than the transmit power, so that in addition to the spherical waveguide, the circular waveguide, the coaxial line, and the SIW, a strip line or a micro strip line may be used as the leakage transmission line.

FIG. 5 shows an example of a bandwidth for the radar system of the present invention, when four center frequencies are assigned in the Ku band.

As described above, beam steering in the elevation direction may be performed through center frequency conversion. Here, when four center frequencies are assigned in the Ku band, the bandwidth for the system may be the same as the example shown in FIG. 5. However, the number of center frequencies is only an example and is not limited to the above-described embodiment. Here, the number of center frequencies may be required to be equal to the number of beams to be steered in the elevation direction. Further, as described above, the characteristic of the traveling wave leakage line is that the direction of the beam to be steered changes when converting the center frequency. The number P of leakage slots in each line may be a value that is required to be adjusted according to the beam width in the elevation direction and the beam gain. In the meantime, the beam in the azimuth direction may be steered by adjusting the phase, the value of the digital attenuator, and the like. That is, with respect to the elevation direction, center frequency conversion is considered, and with respect to the azimuth direction, phase shift and the digital attenuator are used.

FIG. 6 is a scan timing diagram in which phase noise of FMCW radar is reduced and the scan time is minimized. Here, FIG. 6 is a diagram in the case of performing scanning in the elevation direction and the azimuth direction with respect to the spatial cell as shown in FIG. 1.

Further, as an example, the radar panel may be fixed without rotating in any direction. Here, every determined period, the direction of the beam changes to detect the target. Here, frequency conversion may occur in conversion of the beam direction to the elevation direction. Here, in order to minimize the number of times that frequency conversion is performed, after beam conversion in the elevation direction, beam steering in the azimuth direction may be performed in order, which is described above.

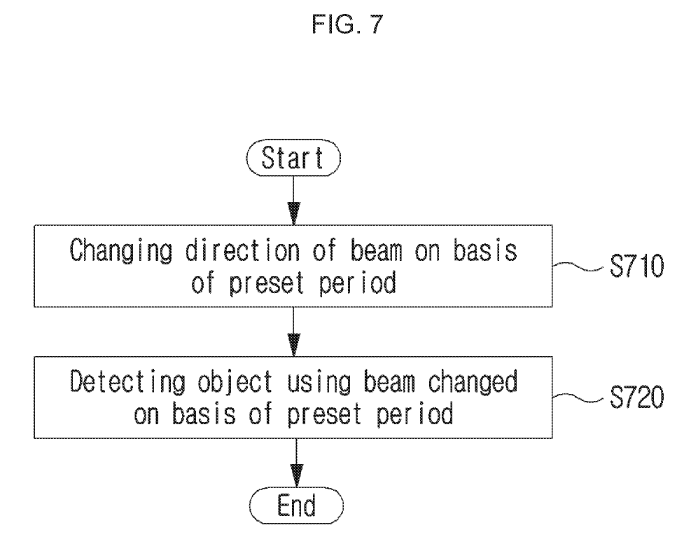

FIG. 7 is a flowchart illustrating a method of sensing illegal flight of a low-flying drone.

Referring to FIG. 7, the beam direction may be changed on the basis of a preset period at step S710. Next, the object may be detected using the beam changed on the basis of the preset period at step S720. Here, as described above with reference to FIGS. 1 to 6, for example, the preset period may be as shown in FIG. 6. That is, the period for the full scan may be set, and the period may be set on the basis of center frequency change and azimuth change, which is described above. Here, for example, regarding the beam direction, a first direction may be set as the elevation direction and a second direction may be set as the azimuth direction. Here, for the beam direction, an element for steering the beam, such as a transmission and reception unit or a transmission and reception module, may be required. However, when the above-described elements are mounted considering both the elevation direction and the azimuth direction the cost of the apparatus may increase and the configuration of the apparatus may be complex. On the basis of the above description, the elevation direction may be changed by changing the center frequency. That is, different bands may be set for respective elevation directions, and the elevation direction may be changed by changing the frequency. In the meantime, the azimuth may be changed on the basis of phase or another particular value. Here, the azimuth may be, as described above, changed on the basis of phase shift or digital attenuation. For example, one transmission and reception unit or one transmission and reception module may be required for each azimuth direction. That is, transmission and reception units or transmission and reception modules may be required as many as the number of azimuth directions that are able to be changed, and it is not limited to the above-described embodiment.

In the meantime, regarding the beam direction, the beam in the elevation direction may be to changed first, and on the basis thereof, the beam in the azimuth direction may be changed. More specifically, at a first center frequency, the elevation direction may be a first direction. Here, as the first center frequency, the azimuth direction may be changed while maintaining the first direction. Here, sequential changes are possible with respect to the azimuth directions that are able to be changed. As the first direction, the elevation direction may be maintained. After all the azimuth directions are changed in order, the first center frequency may be changed into a second center frequency. Here, on the basis of the second center frequency, the elevation direction may be maintained as the second direction. Here, while maintaining the second direction, all the azimuth directions may be changed in order. That is, using the above-described method, detection may be performed with respect to the entire area, and the object may be detected. In the meantime, the object may be a target, another unmanned device, or the like without being limited to the above-described embodiment.

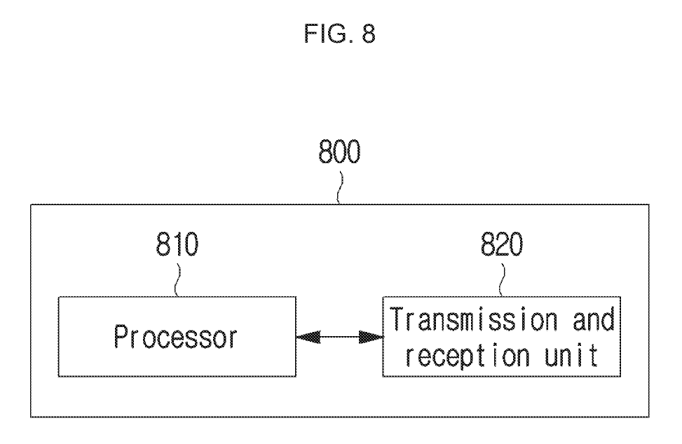

FIG. 8 is a diagram illustrating a configuration of an apparatus according to an embodiment of the present invention. Referring to FIG. 8, the apparatus 800 may be an apparatus for sensing illegal flight of a low-flying drone. Further, for example, it may be an apparatus that includes at least one among the EO/IR device, the radar panel, the support, and the command/control device shown in FIG. 1. Furthermore, the apparatus 800 in FIG. 8 may be a system for sensing illegal flight of a low-flying drone and may include the above-described configuration shown in FIG. 1. For example, the apparatus 800 in FIG. 8 may be a hardware configuration based on the above description. Here, the apparatus 800 in FIG. 8 may be an apparatus that performs the operations shown in FIGS. 1 to 7 in combination with another apparatus or device. Further, for example, the apparatus 800 in FIG. 8 may be a software configuration as a logical entity. That is, it may be an operation based on an operation necessary for performing the operations in FIGS. 1 to 7, and it is not limited to the above-described embodiment.

In the meantime, referring to FIG. 8, the apparatus 800 may include a processor 810 and a transmission and reception unit 820. Further, although not shown in the drawings, other necessary units or configurations may be included without being limited to the above-described embodiment.

Here, for example, the processor 810 may be a logical entity or a hardware configuration for controlling the operations in FIGS. 1 to 7. Further, for example, the transmission and reception unit 820 may be a logical entity or a hardware configuration for performing the operation of steering the beam, and it is not limited to the above-described embodiment.

Here, for example, as described above, azimuth direction change may be performed on the basis of the transmission and reception unit 820, which is described above. That is, the configuration in FIG. 8 may be a configuration for performing the operations in FIGS. 1 to 7, and it is not limited to the above-described embodiment.

The detailed description of the exemplary embodiments of the present invention has been given to enable those skilled in the art to realize and implement the present invention. Although the present invention has been described with reference to the exemplary embodiments, those skilled in the art will appreciate that various modifications and variations can be made in the present invention without departing from the spirit or scope of the invention described in the appended claims. Accordingly, the invention should not be limited to the embodiments described herein, but should be accorded the broadest scope consistent with the principles and novel features disclosed herein. Although the exemplary embodiments of the present invention have been illustrated and described above, the present invention is not limited to the aforesaid particular embodiments, and can be variously modified by those skilled in the art without departing the gist of the present invention defined in the claims. The modifications should not be understood individually from the technical idea or perspective of the present invention.

In addition, the present invention describes both a device invention and a method invention, and descriptions of both inventions may be complementarily applied as needed.

Also, the exemplary embodiments of the present invention have been particularly described. It will be understood by those skilled in the art that various changes in form are possible without departing from the essential features of the invention. Thus, the exemplary embodiments should be considered in a descriptive sense only and not for purposes of limitation. Therefore, the scope of the invention is defined not by the detailed description of the invention but by the following claims, and all differences within the scope will be construed as being included in the exemplary embodiments.

What is claimed is:

1. A method of sensing illegal flight of a low-flying drone, the method comprising:
changing a direction of a beam on the basis of a preset period; and
detecting an object by using the beam changed on the basis of the preset period,
wherein the direction of the beam is changed on the basis of a first direction and a second direction,
the first direction is changed on the basis of conversion of a center frequency, and
the second direction is changed on the basis of a phase and a particular value.

2. The method of claim 1, wherein at the changing of the direction of the beam on the basis of the preset period, the first direction is changed first, and then the second direction is changed.

3. The method of claim 2, wherein the first direction is set on the basis of a first center frequency, and at the first center frequency, when all sequential changes are performed in a range in which the second direction is able to be changed, the first center frequency is changed into a second center frequency.

4. The method of claim 3, wherein the first direction is set on the basis of the second center frequency, and at the second center frequency, all sequential changes are performed in a range in which the second direction is able to be changed.

5. The method of claim 1, wherein the second direction is changed on the basis of phase shift and digital attenuation.

6. The method of claim 1, wherein the first direction is an elevation direction, and
the second direction is an azimuth direction.

7. The method of claim 1, wherein the number of the center frequencies is four.

8. An apparatus for sensing illegal flight of a low-flying drone, the apparatus comprising:
a transmission and reception unit and
a processor for controlling the transmission and reception unit,
wherein the processor is configured to:
change a direction of a beam on the basis of a preset period; and
detect an object using the beam changed on the basis of the preset period,
the direction of the beam is changed on the basis of a first direction and a second direction,
the first direction is changed on the basis of conversion of a center frequency, and
the second direction is changed on the basis of a phase and a particular value.

9. The apparatus of claim 8, wherein when the direction of the beam direction is changed on the basis of the preset period, the first direction is changed first, and then the second direction is changed.

10. The apparatus of claim 9, wherein the first direction is set on the basis of a first center frequency, and at the first center frequency, when all sequential changes are performed in a range in which the second direction is able to be changed, the first center frequency is changed into a second center frequency.

11. The apparatus of claim 10, wherein the first direction is set on the basis of the second center frequency, and at the second center frequency, all sequential changes are perforated in a range in which the second direction is able to be changed.

12. The apparatus of claim 8, wherein the second direction is changed on the basis of phase shift and digital attenuation.

13. The apparatus of claim 8, wherein the number of the transmission and reception units is set on the basis of a range in which the second direction is able to be changed.

14. The apparatus of claim 8, wherein the first direction is an elevation direction, and
the second direction is an azimuth direction.

15. The apparatus of claim 8, wherein number of the center frequencies is four.

16. A system for sensing illegal flight of a low-flying drone, the system comprising:
an electro-optical and infrared (EO/IR) device;
multiple radar panels; and
a control device for controlling the EO/IR device and the multiple radar panels,
wherein an object is detected by changing a direction of a beam at a preset period in the radar panels,
information on the detected object is transmitted to the control device,
the direction of the beam is changed on the basis of a first direction and a second direction,
the first direction is changed on the basis of conversion of a center frequency, and
the second direction is changed on the basis of a phase and a particular value.
